(19) United States
(12) Patent Application Publication
(10) Pub. No.: US 2020/0212477 A1
(43) Pub. Date: Jul. 2, 2020

(54) High Power Lithium Ion Battery and the Method to Form

(71) Applicant: Weimin Li, New Milford, CT (US)

(72) Inventor: Weimin Li, New Milford, CT (US)

(73) Assignee: Weimin Li, New Milford, CT (US)

(21) Appl. No.: 16/517,601

(22) PCT Filed: Feb. 2, 2018
(86) PCT No.: PCT/US2018/016580

§ 371 Date: Jul. 21, 2019

Related U.S. Application Data
(60) Provisional application No. 62/453,675, filed on Feb. 2, 2017.

(51) Int. Cl. H01M 10/0525; H01M 4/66; H01M 4/62; H01M 4/04; H01M 2/16

(52) U.S. Cl. CPC H01M 10/0525; H01M 4/66; H01M 2004/027; H01M 4/0404; H01M 2/1673; H01M 4/621

(57) ABSTRACT

A lithium ion battery and method of making an electrode is disclosed. The lithium ion battery may comprise an anode, a cathode, a separator. The anode may comprise negative electrode material and a negative current collector. The cathode may comprise positive electrode material and a positive current collector. The negative or positive electrode material forms a continuous negative or positive electrode material layer on the negative or positive current collector. The separator may separate the anode and the cathode. At least one continuous electrode material layer may include a plurality of vertical structures. The vertical structures may have depths into the current collector and sidewalls. The sidewalls may define the plurality of vertical structures. The plurality of the vertical structures may be configured in an array.

### RELATED APPLICATIONS

This application claims priority to and benefit from a PCT patent application No. PCT/US2018/16580, filed on Feb. 2, 2018, which claims priority to and benefit from U.S. Provisional Application No. 62/453,675, filed on Feb. 2, 2017, which is hereby incorporated by reference herein in its entirety.

### TECHNICAL FIELD

The present disclosure relates generally to batteries, and more particularly to higher power lithium battery and method to form.

### BACKGROUND

The growing market for lightweight, portable cordless consumer products, such as CD-players, mobile telephones, laptop computers, and video cameras has led to an increased demand for high-density batteries. Specifically, very thin and flexible batteries are required. In order to provide an acceptable portability, the batteries contained in said consumer products should provide the necessary amount of energy at the smallest possible weight and volume. However, the thinner the battery, the more difficult the application of a pressure needed to maintain a sufficient contact between the respective components of the battery.

Lithium is a very advantageous material for use in batteries in which a high energy density is required. Lithium is the lightest of all metals, which promises an extremely high theoretical energy density of metallic lithium. Lithium is a leading contender in the field of negative battery electrode materials, since it has a large negative thermodynamic potential. Moreover, the use of lithium has no negative environmental consequences. Thus, lithium batteries are very promising, especially where weight is an important factor.

The lithium batteries are broadly categorized as a jelly-roll type (winding-type) and a stack-type (laminate-type) according to the structure of the electrode assembly. For example, a jelly-roll type electrode assembly is prepared in such a manner that a metal foil used as a current collector is coated with an electrode active material, dried, and pressed to prepare an electrode, the electrode is cut in the shape of a band having desired width and length, and the jelly-roll type electrode assembly is then prepared by separating a cathode and an anode using a separator and winding the resultant product in a spiral shape. The jelly-roll type electrode assembly is appropriate for a cylindrical type battery. However, the jelly-roll type electrode assembly may have disadvantages, such as the exfoliation of the electrode active material and low space utilization, when used in a prismatic type or pouch type battery. The stack-type electrode assembly has a structure in which a plurality of cathode and anode units are sequentially stacked, wherein the stack-type electrode assembly may have advantages in that a prismatic shape may be easily obtained, but may have disadvantages in that a preparation process is cumbersome and an electrode is pushed to cause a short circuit when an impact is applied thereto.

In order to address the above limitations, an electrode assembly may have a structure, in which a predetermined sized full cell composed of cathode/separator/anode or a predetermined sized bi-cell composed of cathode (anode)/separator/anode (cathode)/separator/cathode (anode) is sequentially stacked to allow the cathode and the anode to face each other in the state of disposing a long continuous separation film therebetween.

Fast charging lithium ion batteries have huge potential market size on demand due to their shortened charging time which can be as quickly as refueling for gas-powered vehicles. However, high-rate recharge produces sudden heating, which gives rise to a fire hazard for high-power batteries with high-cost metallic lithium anode as well as new high-capacity anode materials.

Therefore, there is a need for fast and safe charging lithium ion batteries.

### SUMMARY

According to a first aspect, a lithium ion battery comprises an anode, a cathode, a separator. The anode may comprise a negative electrode material and a negative current collector. The cathode may comprise a positive electrode material and a positive current collector. The negative or positive electrode material forms a continuous negative or positive electrode material layer on the negative or positive current collector. The separator may separate the anode and the cathode. At least one continuous electrode material layer may include a plurality of vertical structures. The vertical structures may have depths into the current collector and sidewalls. The sidewalls may define the plurality of vertical structures. The plurality of the vertical structures may be configured in an array.

In certain aspects, the array may be hexagonal.

In certain aspects, the continuous negative or positive electrode material layer may have a thickness from about 50 microns to about 300 microns.

In certain aspects, the continuous negative or positive electrode material layer may have a thickness from about 80 microns to 300 microns.

In certain aspects, the continuous negative or positive electrode material layer may have a thickness from about 100 microns to 300 microns.

In certain aspects, the continuous negative or positive electrode material layer may have a thickness from about 150 microns to 300 microns.

In certain aspects, the depth of the vertical structure may be from about 25 microns to about 250 microns.

In certain aspects, the depth of the vertical structure may be about 100 microns.

In certain aspects, the vertical structures may be spaced from about 50 microns to about 500 microns.

In certain aspects, the vertical structures may be spaced from about 100 microns to about 400 microns.

In certain aspects, the vertical structures may be spaced from about 200 microns to about 300 microns.

In certain aspects, the lithium ion battery has a high-power capacity of 180 Wh/kg at a charging rate of 6 C.

According to a second aspect, a method of preparing an electrode may include steps of providing a current collector; mixing an active material, binder, and conductive materials to form a mixture; putting the mixture through a screen; coating one side of the current collector with the screened mixture to form a coated current collector; drying the coated current collector to form a dried coated current collector; and cutting the dried coated current collector to a predetermined size.

In certain aspects, the screen may have a plurality of openings.

In certain aspects, the plurality of openings may be configured in an array and may be surrounded by a plurality of sidewalls.

In certain aspects, the plurality of sidewalls may have heights from about 25 microns to about 250 microns.

In certain aspects, the plurality of sidewalls may have heights from about 50 microns to about 200 microns.

In certain aspects, the plurality of sidewalls may have heights from about 100 microns to about 150 microns.

In certain aspects, the plurality of sidewalls may have heights about 100 microns.

In certain aspects, the openings may be spaced from about 50 microns to about 500 microns.

In certain aspects, the openings may be spaced from about 100 microns to about 400 microns.

In certain aspects, the openings may be spaced from about 200 microns to about 300 microns.

According to a third aspect, a method of preparing an electrode may comprise steps of providing a current collector; mixing an active material, binder, and conductive materials to form a mixture; coating one side of the current collector with the mixture to form a coated current collector; forming a plurality of vertical structures on the coated current collector, wherein the plurality of vertical structure have depths into the current collector, the plurality of the vertical structures are configured in an array; and cutting the coated current collector to a predetermined size.

In certain aspects, the sidewalls may have heights from about 25 microns to about 250 microns.

In certain aspects, the sidewalls may have heights from about 50 microns to about 200 microns.

In certain aspects, the sidewalls may have heights from about 100 microns to about 150 microns.

In certain aspects, the sidewalls may have heights from about 100 microns.

In certain aspects, the plurality of vertical structures may be spaced from about 50 microns to about 500 microns.

In certain aspects, the plurality of vertical structures may be spaced from about 100 microns to about 400 microns.

In certain aspects the plurality of vertical structures may be spaced from about 200 microns to about 300 microns.

In certain aspects, the method may further comprise drying the coated current collector before forming a plurality of vertical structures.

In certain aspects, the method may further comprise drying the coated current collector after forming a plurality of vertical structures.

In certain aspects of the method, the drilling may comprise a jet drilling or a laser drilling.

According to the fourth aspect, a method of preparing an electrode may be carried out by steps of providing a current collector; mixing an active material, binder, and conductive materials to form a mixture; putting the mixture through an array of nozzles, and onto one side of the current collector with the mixture to form a coated current collector with a plurality of vertical structures on the coated current collector, wherein the plurality of vertical structure have depths into the current collector; forming the plurality of the vertical structures are configured in an array; and cutting the coated current collector to a predetermined size.

### DESCRIPTION OF THE DRAWINGS

These and other advantages of the present invention may be readily understood with the reference to the following specifications and attached drawings wherein:

FIG. 1 illustrates a perspective view of exemplary layers of a lithium ion battery in accordance with an aspect of the present disclosure.

FIG. 2 illustrates a cross-sectional view of an electrode structure according to one aspect of the present disclosure.

FIG. 3 illustrates a modeling of capacity at various electrode thickness.

FIGS. 4a-4b illustrate modeling of volumes taken out by radius and spacing of punching vertical structures.

FIG. 5a illustrates an electrode with vertical structures shows 30% higher capacity at 2 C rate than electrode without vertical structures.

FIG. 5b illustrates a scanning electron microscope picture of an electrode according to one embodiment.

FIG. 6 illustrates a flow chart of a method of preparing an electrode according to one embodiment.

FIG. 7 illustrate a method of making an electrode by using a screen.

FIG. 8 illustrates a flow chart of a method of preparing an electrode according to another embodiment.

FIG. 9 illustrates a flow chart of a method of preparing an electrode according to yet another embodiment.

### DETAILED DESCRIPTION

Preferred embodiments of the present disclosure may be described herein below with reference to the accompanying drawings. In the following description, well-known functions or constructions are not described in detail because they may obscure the disclosure in unnecessary detail. For this disclosure, the following terms and definitions shall apply.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

It will be understood that the terms vertical and horizontal are used herein refer to particular orientations of the figures perpendicular to one another and these terms are not limitations to the specific embodiments described herein.

Additionally, variations to the disclosed embodiments can be understood and effected by the skilled person in practicing the claimed disclosure, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

Also, two or more steps may be performed concurrently or with partial concurrence. Further, the steps of the method may be performed in an order different from what has been disclosed. Such variation will depend on the process hardware systems chosen and on designer choice. All such variations are within the scope of the disclosure. Additionally, even though the disclosure has been described with reference to specific exemplifying embodiments thereof, many different alterations, modifications and the like will become apparent for those skilled in the art.

Embodiments include a lithium ion battery and a method of making it. More specifically, the present disclosure discloses a novel battery electrode architecture where a hexagonal array of straight vertical structures, for example, is created from the surface of the electrode toward, but not reaching a current collector. With a thicker electrode, the proposed technology may deliver 180 Wh/kg of stored energy at 6 C.

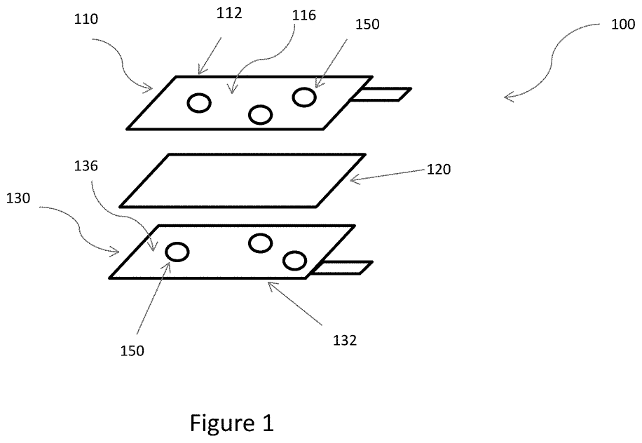

As shown in FIG. 1, a lithium ion battery 100 may comprise an anode 110, a separator 120, and a cathode 130. The anode 110 may comprise a negative electrode material and a negative current collector 112, such as Cu. The cathode 130 may comprise a positive electrode material and a positive current collector 132, such as Al. In one embodiment, the negative electrode material may form a continuous negative electrode material layer 116 on the negative current collector 112. The positive electrode material may form a continuous positive electrode material layer 136 on the positive current collector 132. The separator 120 may separate the anode 110 and the cathode 130. In one embodiment, the continuous negative or positive electrode material layer 116 or 136 may have a thickness from about 50 microns to about 300 microns, for example. In another embodiment, the continuous negative or positive electrode material layer 116 or 136 may have a thickness from about 80 microns to 300 microns, for example. In further embodiment, the continuous negative or positive electrode material layer may have a thickness from about 100 microns to 300 microns, for example, preferably from about 150 microns to 300 microns. In one embodiment, the depth of the vertical structure may be from about 25 microns to about 250 microns. In another embodiment, the depth of the vertical structure may be about 100 microns, for example.

In one embodiment, at least one continuous electrode material layer, such as the continuous negative electrode material layer 116 or the positive current collector 132, may include a plurality of vertical structures 150.

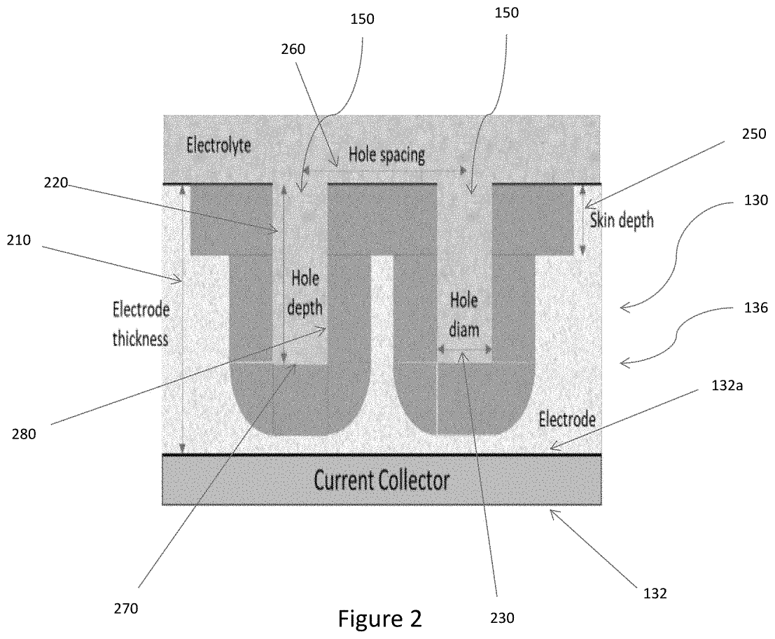

As shown in FIG. 2, the plurality of vertical structures 150 on the continuous positive electrode layer 136 of the cathode 130 may have depths 220 into the current collector 132. The plurality of vertical structure 150 may further include sidewalls 280, which defines the plurality of vertical structures 150. The plurality of vertical structures 150 may be configured in an array with spacing 260 and diameter 230. In one embodiment, the vertical structures may be spaced from about 50 microns to about 500 microns. In another embodiment, the vertical structures may be spaced from about 100 microns to about 400 microns, preferably from about 200 microns to about 300 microns, for example.

The vertical structure 150 may extend vertically through the continuous electrode layers 136. In some embodiments, the vertical structure 150 of the cathode 130 may have at least one end portion extending substantially perpendicular to a major surface 132a of the current collector 132, as shown in FIG. 2. “Substantially perpendicular to” (or “substantially parallel to”) means within about 0-10°. For example, the vertical channel structure 150 may have a pillar shape and the entire pillar-shaped vertical structure may extend substantially perpendicularly to the major surface 132a of the current collector 132, as shown in FIG. 2.

Alternatively, the vertical structure 150 may have various shapes, which may not be substantially perpendicular to the major surface 132a of the current collector 132.

The energy capacity of a battery may be determined by a total amount of electrode materials in the battery. The thickness 210 of each electrode layer, such as the cathode 130, which includes current collector 132 and continuous electrode material layer 136, may be typically 50-100 microns. Given the volume constrained of a battery, thicker electrode may be desired for two reasons. Firstly, the thicker the electrode layer, the smaller number of layers needed. The smaller number of separators 120, the more volume percentage for electrode materials.

Secondly, with the same manufacturing equipment, the thicker the electrodes, the higher the battery capacity output for the same equipment. Thus, increasing the thickness of the electrode may significantly reduce the manufacturing cost through the increase of production capacity.

However, current lithium ion battery thickness is about 50-100 microns. There are two primary reasons for the limitation of the electrode thickness. Firstly, it may already take very long to dry the electrode, as the majority of electrode coating equipment footprint is for drying. Making it thicker would make the drying process too long or may never achieve complete drying. Secondly, the electrolyte may not be able to penetrate to more than 50-100 microns due to capillary effect, as the electrode particles are packed. The opening path for the electrolyte may be much longer. Without electrolyte to transport ions or if the ions take long time to travel through the electrode, it may take very long time to charge or discharge the battery, which may make the battery power much lower.

More specifically, as charging rate increase, lithium ions (Li⁺) can only penetrate a thinner layer of the electrode due to tortuosity (skin depth 250). The stored energy at higher charging rates may be reduced from the total capacity. Assuming a 50-micron thick electrode (for a typical state-of-the-art battery), the skin depth at the 6 C is approximately 35 microns.

In the exemplary embodiment as shown in FIG. 2, electrolytes may carry lithium ions straight to the bottom of the vertical structures near the current collector 132. Lithium ion may diffuse from the sidewall 280 and the bottom 270 into the electrode. Since lithium ion conductivity in the electrolyte is on the order of 10⁻² S.cm⁻¹, lithium ion may transport in the vertical structures 150 almost instantaneous compared to transport within the electrode film. Increasing the electrode thickness may help to obtain a higher energy capacity at a fast charge rate.

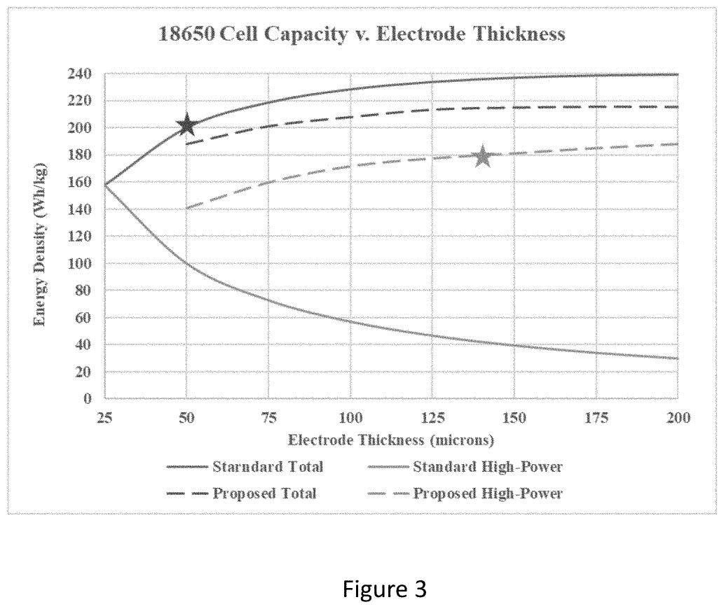

A lithium ion battery cell's total and high-power capacity can be modelled as a function of electrode thickness, as shown in FIG. 3. A 25 μm high power skin depth may be used for a charging rate of 6 C or higher. A typical repeating stack, such as cathode (anode)/separator/anode (cathode)/separator/cathode (anode) is sequentially stack in an 18650-cell confinement may be assumed. A 50 μm standard electrode and 200 Wh/kg total capacity may be used to represent the state-of-the-art lithium ion battery performance (the left star on FIG. 3). For the proposed electrode, the vertical structure diameter is set at 25 μm and spacing is set at 100 μm. While standard electrodes have decreasing high-power capacity with increasing thickness, the proposed electrode structure has increasing high-power capacity. 180 Wh/kg can be achieved with 140 μm thick electrode at 6 C (the right star).

Thicker electrodes may mean a lower number of repeating stacks in a fixed battery geometry, eliminating portions of the separators and current collectors. Due to a higher active vs non-active materials ratio, the total capacity with 140 μm proposed electrode may reach 214 Wh/kg, 7% higher than the state-of-the-art battery. A study has showed $/kWh can be lowered significantly by doubling the electrode thickness, mainly because of lower non-active materials cost and higher electrode processing throughput as measured by Wh/coating area/time.

Currently, electrode films may be modelled as closely packed spherical particles with a uniform radius R. Smaller conductive carbon additives are spherical particles with radius r (r<<R). Nonetheless, these small particles reside between the large particles, can increase the tortuosity of the electrode film, and make it hard for electrolyte to fill in completely.

If the electrode materials are packed as a dense film, with cylindrical vertical structures through the electrode film, the distance between vertical structures may be on the order of 50 microns. In this case, electrolyte has a straight path through the whole film. Even though the whole electrode thickness is much thicker, the effective penetration depth for electrolyte may be only 50 microns. Thus, a very thick electrode battery may have the same power.

A cube of closely packed balls with radius=R, the volume percentage is:

$$Volume \% = \frac{π}{3 \sqrt{2}} = 74.05 \%$$

For a battery electrode of width of W, length of L and thickness of 50 microns, the volume of electrode materials is 50×WL×74.05%=37 WL

A closely packed cylinder with cross-sectional radius of R, the cross-section surface of percentage

$$Area \% = \frac{π}{2 \sqrt{3}} = 90.69 \%$$

For a battery electrode of width of W, length of L and thickness of 50 microns, the volume of electrode materials is: 50×(WL×90.69%)=45.35%. If each cylinder consists of a single column of balls, the volume % will be: 45 WL×52%=23.5 WL. If the cylinder consists of closely packed balls, the volume %=45 WL×74%=33.3%.

However, if it is equivalent of punching vertical structures with radius of 1 micron through closely packed electrode, the vertical structures are spaced hexagonally at 50 microns. Then the volume taken out will be area percentage, equivalent of 2 circles of radius 1, and hexagonal with side of 50=2 πr²(7500 sin 60). If r=5 microns, the area taken out will be about 2.5%. If r=10 microns, the area taken out will be about 10%. Below table is vertical structure diameter/vertical structure spacing:

Diameter/spacing (micron)

| | 0 | 2/50 | 10/50 | 20/50 | 20/100 |
|---|---|---|---|---|---|
| Volume % | 74% | 73.9% | 72.15% | 66.6% | 72.15% |

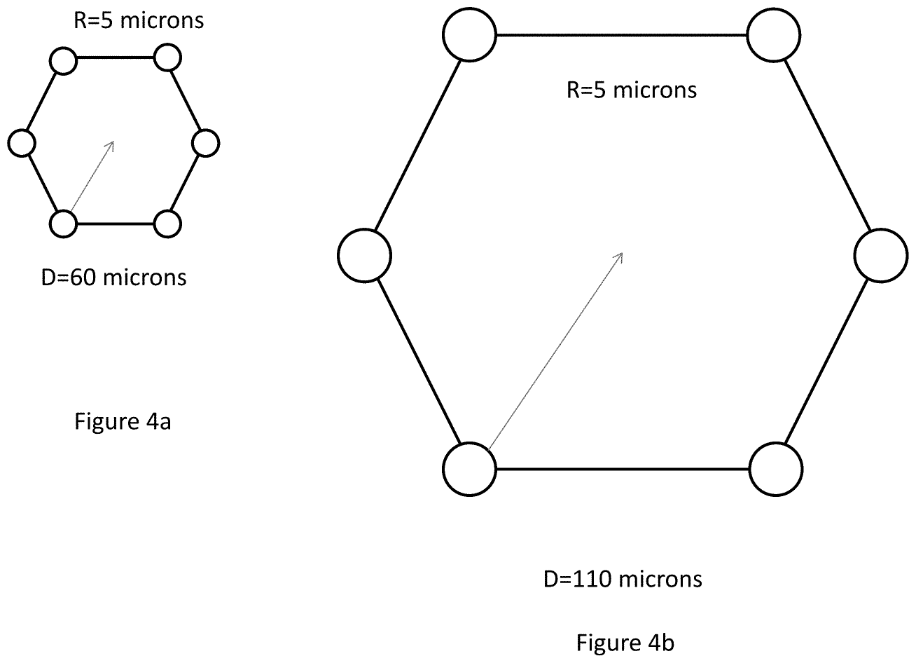

To ensure that the further point to the vertical structure is around 50 microns, there can be two types of designs, as shown FIGS. 4a and 4b.

For design shown in FIG. 4a,

$$\text{Vertical structure area \%} = \frac{2 π {R}^{2}}{3 {D}^{2} sin 60} = 1.68 \%$$

For design shown in FIG. 4b,

$$\text{Vertical structure area \%} = \frac{π {R}^{2}}{3 {D}^{2} sin 60} = 0.75 \%$$

| | Diameter/spacing (micron) | | |
|---|---|---|---|
| | No vertical structure | 10/50 FIG. 4a | 10/110 FIG. 4b |
| Volume % | 74% | 72.76% | 73.45% |

An exemplary embodiment of the present disclosure can achieve 180 Wh/kg at 6 C.

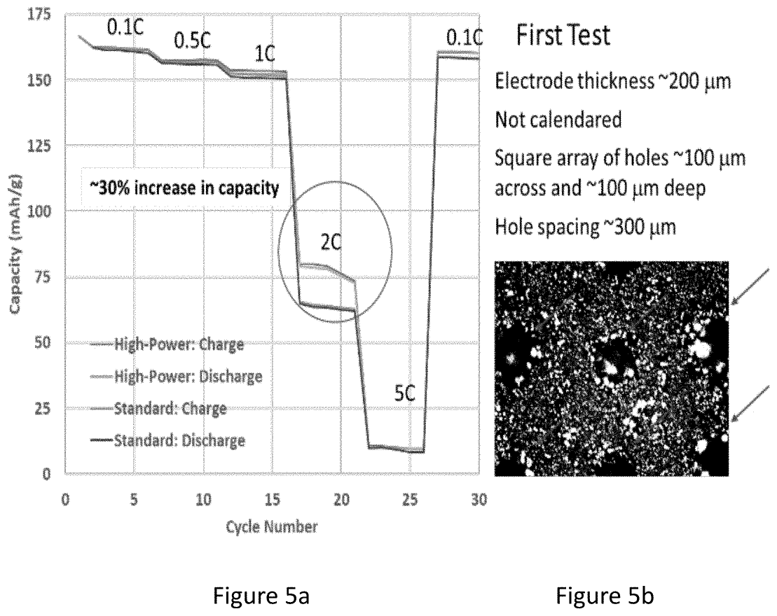

As shown in FIG. 5a, coin cells having electrodes with vertical structures have shown 30% more capacity than without vertical structures at cycle 2 C.

As shown in FIG. 5b, electrode thickness may be about 200 microns with a square array of vertical structures about 100 microns diameter and about 100 microns deep. The vertical structure may have spacing about 300 microns.

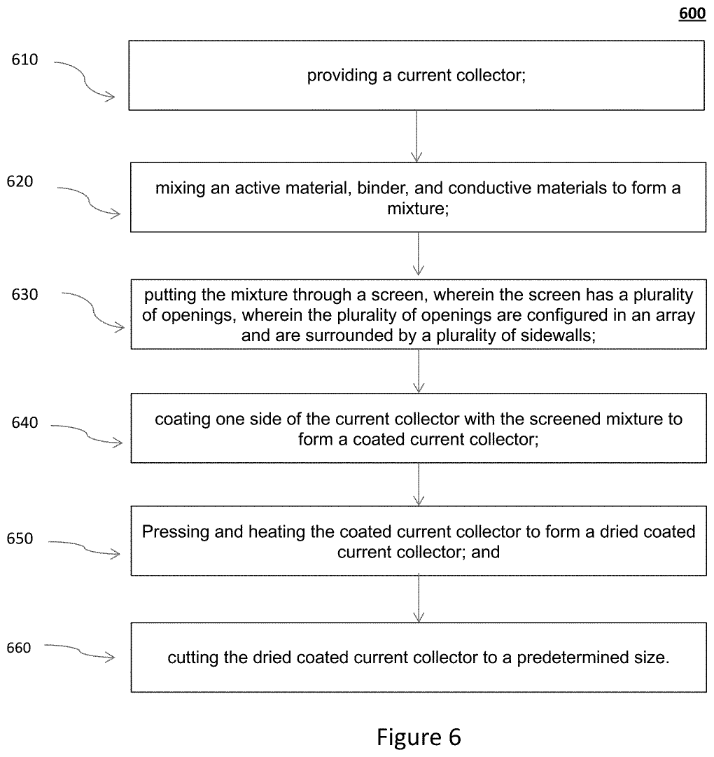

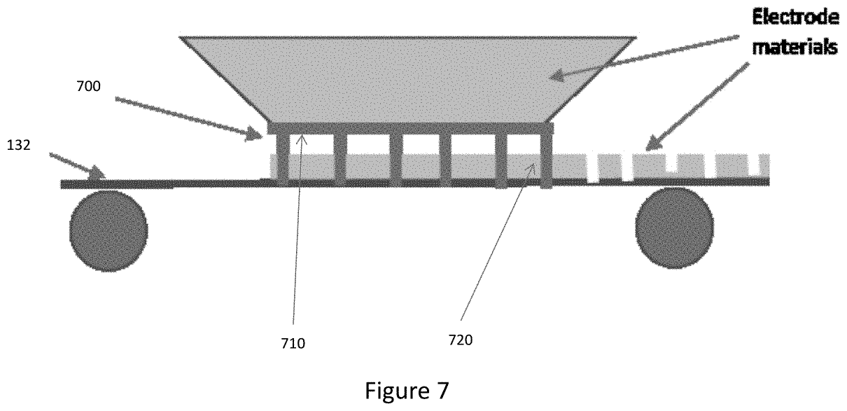

As shown in FIG. 6, in one embodiment a method 600 of preparing an electrode may be carried out by providing a current collector in a step 610 and mixing an active material, binder, and conductive materials to form a mixture in a step 620. The active material, such as electrode particles are mixed with binders, conductive additives with organic conductive material, such as NMP, for example. The method 600 may further be carried out by putting the mixture through a screen 700 in a step 630. The mixture may flow through the openings 710 due to gravity. The method 600 may be further carried out by coating one side of the current collector 132 with the screened mixture to form a coated current collector as shown in FIG. 7. The dried coated current collector may be cut to a predetermined size.

As shown in FIG. 7, the screen 700 may have a plurality of openings 710. The plurality of openings 710 may be configured in an array and are surrounded by a plurality of sidewalls 720. In one embodiment, the opening may be spaced from about 100 microns to about 400 microns, for example. In another embodiment, the opening may be spaced from about 200 microns to about 300 microns, for example. In one embodiment, the plurality of sidewalls may have heights from about 25 microns to about 250 microns, for example. The plurality of sidewalls may have heights from about 50 microns to about 200 microns, for example. In further embodiment, the plurality of sidewalls may have heights from about 100 microns to about 150 microns. In yet another embodiment, the plurality of sidewalls may have heights about 100 microns.

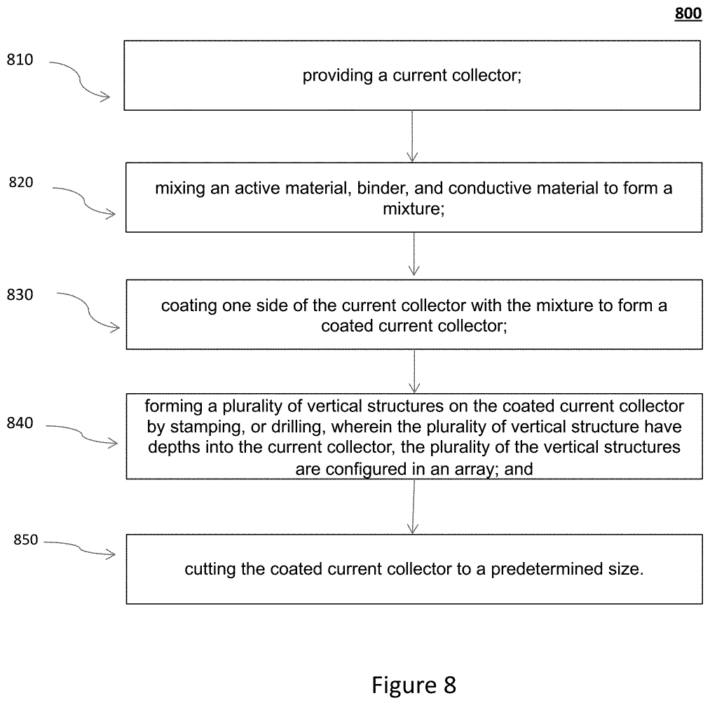

As shown in FIG. 8, a method 800 of preparing an electrode may be carried out by providing a current collector in a step 810; mixing an active material, binder, and conductive material s to form a mixture in a step 820. The method may be further carried out by coating one side of the current collector with the mixture to form a coated current collector in a step 830; forming a plurality of vertical structures on the coated current collector by stamping, or drilling, wherein the plurality of vertical structure have depths into the current collector, the plurality of the vertical structures are configured in an array in a step 840; cutting the coated current collector to a predetermined size in a step 850.

In one embodiment, the drilling may comprise a jet drilling or laser drilling, for example. Laser beam may be placed at various locations of the electrode coating line. In one embodiment, drying the coated current collector may be done before forming a plurality of vertical structures. In another embodiment, drying the coated current collector may be done after forming a plurality of vertical structures. In addition, the laser beam or stamps can be added to battery mass-production lines without significant changes to either equipment or process.

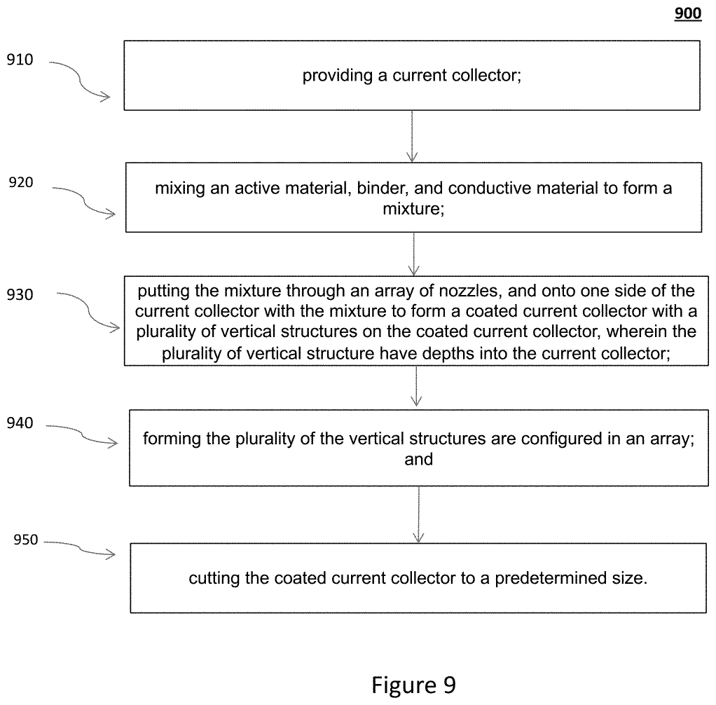

As shown in FIG. 9, a method 900 of preparing an electrode may be carried out by providing a current collector in a step 910; mixing an active material, binder, and conductive material s to form a mixture in a step 920. The method 900 may further include a step of putting the mixture through an array of nozzles, and onto one side of the current collector with the mixture to form a coated current collector with a plurality of vertical structures on the coated current collector in a step 930. The plurality of vertical structure may have depths into the current collector. The method 900 may further by carried out by forming the plurality of the vertical structures are configured in an array in a step 940; and cutting the coated current collector to a predetermined size in a step 950.

In one embodiment, the array may be hexagonal. In one embodiment, the depths may be from about 25 microns to about 250 microns, for example. In another embodiment, the depths may be from about 50 microns to about 200 microns, for example. In further embodiment, the depths may be from about 100 microns to about 150 microns, for example. In yet another embodiment, the depths may be about 100 microns, for example.

In one embodiment, the plurality of vertical structures may be spaced from about 50 microns to about 500 microns, for example. In another embodiment, the plurality of vertical structures may be spaced from about 100 microns to about 400 microns, for example. In yet another embodiment, the plurality of vertical structures may be spaced from about 200 microns to about 300 microns, for example.

The above-cited patents and patent publications are hereby incorporated by reference in their entirety. Although various embodiments have been described with reference to a particular arrangement of parts, features, and like, these are not intended to exhaust all possible arrangements or features, and indeed many other embodiments, modifications, and variations may be ascertainable to those of skill in the art. Thus, it is to be understood that the invention may therefore be practiced otherwise than as specifically described above.

1. A lithium ion battery comprising:
an anode comprising a negative electrode material and a negative current collector;
a cathode comprising a positive electrode material and a positive current collector, wherein the negative or positive electrode material forms a continuous negative or positive electrode material layer on the negative or positive current collector; and
a separator separating the anode and the cathode, wherein at least one continuous electrode material layer includes a plurality of vertical structures having
depths into the current collector, the plurality of the vertical structures are configured in an array, and
sidewalls defining the plurality of vertical structures.

2. The lithium ion battery of claim 1, wherein the array is hexagonal.

3. The lithium ion battery of claim 1, wherein the continuous negative or positive electrode material layer has a thickness from about 50 microns to about 300 microns.

4. The lithium ion battery of claim 1, wherein the continuous negative or positive electrode material layer has a thickness from about 80 microns to 300 microns.

5. The lithium ion battery of claim 1, wherein the continuous negative or positive electrode material layer has a thickness from about 100 microns to 300 microns.

6. The lithium ion battery of claim 1, wherein the continuous negative or positive electrode material layer has a thickness from about 150 microns to 300 microns.

7. The lithium ion battery of claim 1, wherein the depth of the vertical structure is from about 25 microns to about 250 microns.

8. The lithium ion battery of claim 1, wherein the depth of the vertical structure is about 100 microns.

9. The lithium ion battery of claim 1, wherein the vertical structures are spaced from about 50 microns to about 500 microns.

10. The lithium ion battery of claim 1, wherein the vertical structures are spaced from about 100 microns to about 400 microns.

11. The lithium ion battery of claim 1, wherein the vertical structures are spaced from about 200 microns to about 300 microns.

12. The lithium ion battery of claim 1, wherein the lithium ion battery has a high-power capacity of 180 Wh/kg at a charging rate of 6 C.

13. A method of preparing an electrode, comprising:
providing a current collector;
mixing an active material, binder, and conductive materials to form a mixture;
putting the mixture through a screen, wherein the screen has a plurality of openings, wherein the plurality of openings is configured in an array and is surrounded by a plurality of sidewalls;
coating one side of the current collector with the screened mixture to form a coated current collector;
pressing and heating the coated current collector to form a dried coated current collector; and
cutting the dried coated current collector to a predetermined size.

14. The method of claim 13, wherein the array is hexagonal.

15. The method of claim 13, wherein the plurality of sidewalls have heights from about 25 microns to about 250 microns.

16. The method of claim 13, wherein the plurality of sidewalls have heights from about 50 microns to about 200 microns.

17. The method of claim 13, wherein the plurality of sidewalls have heights from about 100 microns to about 150 microns.

18. The method of claim 13, wherein the plurality of sidewalls have heights about 100 microns.

19. The method of claim 13, wherein the openings are spaced from about 50 microns to about 500 microns.

20. The method of claim 13, wherein the openings are spaced from about 100 microns to about 400 microns.

21. The method of claim 13, wherein the openings are spaced from about 200 microns to about 300 microns.

22. A method of preparing an electrode, comprising:
providing a current collector;
mixing an active material, binder, and conductive materials to form a mixture;
coating one side of the current collector with the mixture to form a coated current collector;
forming a plurality of vertical structures on the coated current collector by stamping, or drilling, wherein the plurality of vertical structure have depths into the current collector, the plurality of the vertical structures are configured in an array; and
cutting the coated current collector to a predetermined size.

23. The method of claim 22, wherein the array is hexagonal.

24. The method of claim 22, wherein the depths are from about 25 microns to about 250 microns.

25. The method of claim 22, wherein the depths are from about 50 microns to about 200 microns.

26. The method of claim 22, wherein the depths are from about 100 microns to about 150 microns.

27. The method of claim 22, wherein the depths are about 100 microns.

28. The method of claim 22, wherein the plurality of vertical structures are spaced from about 50 microns to about 500 microns.

29. The method of claim 22, wherein the plurality of vertical structures are spaced from about 100 microns to about 400 microns.

30. The method of claim 22, wherein the plurality of vertical structures are spaced from about 200 microns to about 300 microns.

31. The method of claim 22 further comprising heating the coated current collector before forming a plurality of vertical structures.

32. The method of claim 22 further comprising heating the coated current collector after forming a plurality of vertical structures.

33. The method of claim 22 further comprising heating the coated current collector while forming a plurality of vertical structures.

34. The method of claim 22 further comprising pressing the coated current collector before forming a plurality of vertical structures.

35. The method of claim 22 further comprising pressing the coated current collector after forming a plurality of vertical structures.

36. The method of claim 22 further comprising pressing the coated current collector while forming a plurality of vertical structures.

37. The method of claim 22, wherein the drilling comprises a jet drilling or a laser drilling.

38. A method of preparing an electrode, comprising:
providing a current collector;
mixing an active material, binder, and conductive materials to form a mixture;
putting the mixture through an array of nozzles, and onto one side of the current collector with the mixture to form a coated current collector with a plurality of vertical structures on the coated current collector, wherein the plurality of vertical structure have depths into the current collector;
forming the plurality of the vertical structures are configured in an array; and
cutting the coated current collector to a predetermined size.

39. The method of claim 38, wherein the array is hexagonal.

40. The method of claim 38, wherein the depths are from about 25 microns to about 250 microns.

41. The method of claim 38, wherein the depths are from about 50 microns to about 200 microns.

42. The method of claim 38, wherein the depths are from about 100 microns to about 150 microns.

43. The method of claim 38, wherein the depths are about 100 microns.

44. The method of claim 38, wherein the plurality of vertical structures are spaced from about 50 microns to about 500 microns.

45. The method of claim 38, wherein the plurality of vertical structures are spaced from about 100 microns to about 400 microns.

46. The method of claim 38, wherein the plurality of vertical structures are spaced from about 200 microns to about 300 microns.
